(19) United States
(12) Patent Application Publication
(10) Pub. No.: US 2011/0138434 A1
(43) Pub. Date: Jun. 9, 2011

(54) SYSTEM AND METHOD FOR A DIGITAL TV CONVERTER WITH IPTV CAPABILITIES

(75) Inventor: John M. Ulm, Pepperell, MA (US)

(73) Assignee: GENERAL INSTRUMENT CORPORATION, Horsham, PA (US)

(21) Appl. No.: 12/634,448

(22) Filed: Dec. 9, 2009

(51) Int. Cl. H04N 7/173

(52) U.S. Cl. 725/114

(57) ABSTRACT

A video content system and method that includes a video server connected to a public communication network and a video content network, and a computing device connected to the video content network and a video display device. The computing device establishes a communication channel between the computing device and the video server. The computing device receives a digital video stream on the communication channel, where the digital video stream includes video data and message data, and the message data includes at least one request to perform a service. The computing device performs the service and sends data on the communication channel, where the data is a response to each request to perform the service. The computing device processes the video data to prepare it for transmission to the video display device.

### BACKGROUND

Cable television operators are currently transforming their hybrid fiber-coaxial (HFC) broadband network to an all-digital system. To alleviate the critical need for additional bandwidth, these providers can replace a single 6 MHz analog channel with a quadrature amplitude modulation (QAM) channel that can support 10-15 standard definition (SD) digital video streams. The Federal Communications Commission (FCC) is accelerating this trend with the recent mandate to remove over-the-air (OTA) analog broadcast television signals. This will result in many of these cable television operators removing most if not all of the analog television channels from the cable plant over the next several years.

A major economic issue facing the cable television operators is accommodating their customers who have a television that only receives analog channels. In some cases, these customers only subscribe to the “basic” tier package with a television that only receives analog channels and does not connect to a set top box (STB). In other cases, these customers have additional televisions in the household some of which only receive analog channels. For the cable television operators to switch to an all-digital system, and still accommodate all of their customers, the cable television operators need to deploy a significant number of “digital television converter” boxes to those customers who have a television that only receives analog channels. This is a significant expense for the cable television operators because these digital television converter boxes will not generate any additional revenue per customer. Since traditional STBs tend to be expensive, there is a need for a device that is targeted to be a fraction of the cost of a low-end STB.

To achieve this target cost necessitates the removal of certain functionality from the device, most notably the Conditional Access logic and the upstream communication path. This means the typical digital television converter cannot view any encrypted content or perform any interactive operations. The typical digital television converter can only view a limited number of digital video streams that it receives in the clear and cannot participate in any of the envisioned next generation television capabilities. These next generation television capabilities include accessing premium content (e.g., Home Box Office (HBO), Cinemax, and Starz), accessing video-on-demand (VOD) and pay-per-view (PPV) content, accessing “unlimited” channels thru Switched Digital Video (SDV) technology, enabling personalized/advanced advertising strategies (a potentially significant new revenue opportunity), supporting network digital video recorder (DVR) functions (e.g., StartOver and LookBack), supporting converged services (e.g., CallerID on the TV), participating in a Service Delivery Platform storefront (e.g., Leapstone), or accepting video content from internet sources (i.e., Internet Protocol television (IPTV) capabilities).

Thus, there is a demand for a cost effective digital television converter that will allow the cable television operators to reap the significant bandwidth gains from an all-digital network, while also allowing for the evolution of the capabilities described above without requiring an expensive truck roll (i.e., dispatching a technician in a truck to install, move, or somehow reconfigure an item of equipment or a wire and cable system), and replacement with a more expensive STB. The presently disclosed invention satisfies this demand.

### SUMMARY

Aspects of the present invention provide a video content system and method that includes a video server connected to a public communication network and a video content network, and a computing device connected to the video content network and a video display device. The computing device establishes a communication channel between the computing device and the video server. The computing device receives a digital video stream on the communication channel, where the digital video stream includes video data and message data, and the message data includes at least one request to perform a service. The computing device performs the service and sends data on the communication channel, where the data is a response to each request to perform the service. The computing device processes the video data to prepare it for transmission to the video display device.

### BRIEF DESCRIPTION OF THE DRAWINGS

FIG. 1 is a network diagram that illustrates one embodiment of the hardware components of a system that performs the present invention.

FIG. 2 is a block diagram that illustrates, in detail, one embodiment of the hardware components shown in FIG. 1.

FIG. 3 is a message flow diagram that illustrates methods according to various embodiments of the present invention.

### DETAILED DESCRIPTION

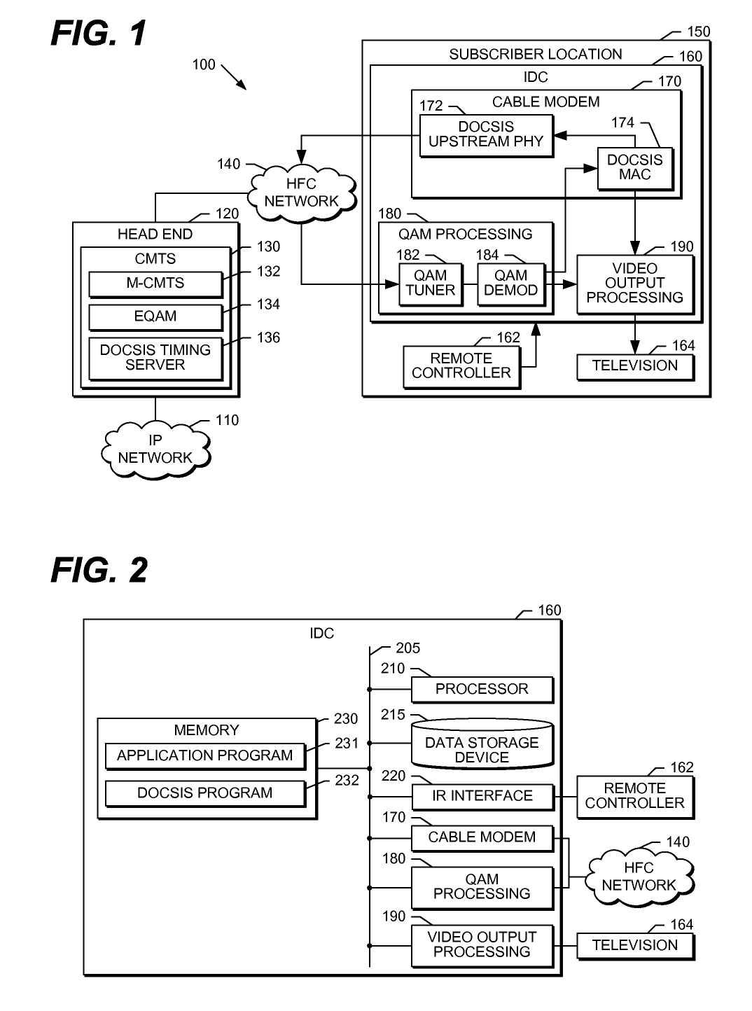

FIG. 1 is a network diagram that illustrates one embodiment of the hardware components of a system that performs the present invention. A broadband network 100 includes an Internet Protocol (IP) network 110 and a hybrid fiber-coaxial (HFC) network 140. The HFC network 140 is a data and video content network that connects a subscriber location 150 to a gateway, such as a cable television head end 120 facility, that provide the subscriber location 150 with various services and/or connections, such as the connection to the IP network 110. For example, the head end 120 may provide a connection to external services such as video servers, public switched telephone network voice, multimedia messages, and internet data. The broadband network 100 shown in FIG. 1 may include any number of interconnected IP networks 110, head ends 120, HFC networks 140, and subscriber locations 150.

The head end 120 is a cable television master head end facility for receiving television signals for processing and distribution over a cable television system. The head end 120 includes a data over cable service interface specification (DOCSIS) cable modem termination system (CMTS) 130. In the embodiment shown in FIG. 1, the CMTS 130 includes a modular CMTS (M-CMTS) 132, an edge quadrature amplitude modulation (EQAM) 134, and a DOCSIS timing server 136. The modular CMTS (M-CMTS) 132 separates a conventional CMTS into two parts, a downstream physical (PHY) component, and a second part that performs IP networking and DOCSIS mandatory access control (MAC) functions for the CMTS. The M-CMTS 132 contains the functions found in a DOCSIS CMTS, including MAC timing and framing, packet classification, service flow management, and security. The EQAM 134 performs the downstream PHY component including radio frequency (RF) transmission functions such as modulation and frequency up-conversion for the transmission of data packets over the HFC network 140. The DOCSIS timing server 136 maintains a consistent timing reference between the M-CMTS 132 and EQAM 134, as well as mitigating the propagation delay differences of these two components. In another embodiment, the CMTS 130 is a traditional CMTS.

The subscriber location 150, in one embodiment, is the premises, such as a home, of a customer such as a cable subscriber. The subscriber location 150 includes an Internet Protocol Television (IPTV) capable Digital Television (DTV) Converter (IDC) 160, a remote controller 162, and a television 164.

The IDC 160 includes a cable modem 170 component, a QAM processing 180 component, and a video output processing 190 component. The QAM processing 180 component includes a QAM tuner 182 that receives an MPEG data stream from the HFC network 140, and a QAM demodulator (demod) 184. The QAM demod 184 demodulates the MPEG transport stream from the HFC network 140 and transmits the digital video stream to the video output processing 190 component, and the DOCSIS message data to the DOCSIS MAC component 174 of the cable modem 170. The cable modem 170 component includes a DOCSIS upstream PHY 172 component, and a DOCSIS MAC 174 component. The DOCSIS MAC 174 component receives DOCSIS message data from the QAM demod 184, and passes packets destined for the IDC 160 to the processor 210. The DOCSIS MAC also receives packets from the processor 210 and sends the DOCSIS message data to the DOCSIS upstream PHY 172 component to transmit the DOCSIS message data to the HFC network 140. This creates a two-way communication path with any device connected to the IP network 110. In one embodiment, the communication path allows a device in the IP network 110 to control and manage the IDC 160 when it is operating like a DTC. In another embodiment, the communication path for the cable modem 170 allows it to receive Internet Protocol television (IPTV), or any other video delivered over an IP network 110 and use the video output processing 190 component to display it on the television 164.

The video output processing 190 component is capable of performing the same functions as a Digital Television (DTV) Converter (DTC) to convert digital television signals to analog television output for the television 164. The video output processing 190 converts the signal from the QAM demod 184 into content that is displayed on the television 164 screen. The IDC 160 supports next generation television capabilities on an analog television by adding DOCSIS capability to the DTV converter. In another embodiment, the IDC 160 can take input from a remote controller 162 device and send messages to a device connected to the IP network 110 to enable advanced television services such as Video-On-Demand (VOD), Switched Digital Video (SDV) or network based Digital Video Recording (nDVR).

The IP network 110 shown in FIG. 1, in one embodiment, is a public communication network or wide area network (WAN) that connects to the head end 120. The present invention also contemplates the use of comparable network architectures. Comparable network architectures include the Public Switched Telephone Network (PSTN), a public packet-switched network carrying data and voice packets, a wireless network, and a private network. A wireless network includes a cellular network (e.g., a Time Division Multiple Access (TDMA), Code Division Multiple Access (CDMA), or Orthogonal Frequency Division Multiplexing (OFDM) network), a satellite network, and a wireless Local Area Network (LAN) (e.g., a wireless fidelity (Wi-Fi) network). A private network includes a LAN, a Personal Area Network (PAN) such as a Bluetooth network, a wireless LAN, a Virtual Private Network (VPN), an intranet, or an extranet. An intranet is a private communication network that provides an organization such as a corporation, with a secure means for trusted members of the organization to access the resources on the organization's network. In contrast, an extranet is a private communication network that provides an organization, such as a corporation, with a secure means for the organization to authorize non-members of the organization to access certain resources on the organization's network. The system also contemplates network architectures and protocols such as Ethernet, Token Ring, Systems Network Architecture, Internet Protocol, Transmission Control Protocol, User Datagram Protocol, Asynchronous Transfer Mode, and proprietary network protocols comparable to the Internet Protocol.

The HFC network 140 is a broadband network that combines optical fiber and coaxial cable, technology that has been commonly employed globally by cable television operators since the early 1990s. The fiber optic network extends from the cable operators master head end, sometimes to regional head ends, and out to a neighborhood hubsite, and finally to a fiber optic node that serves anywhere from 25 to 2000 homes. The master head end will usually have satellite dishes for reception of distant video signals as well as IP aggregation routers. Some master head ends also house telephony equipment for providing telecommunications services to the community. The regional head ends receive the video signal from the master head end and add to it the Public, Educational and/or Governmental (PEG) channels as required by local franchising authorities or insert targeted advertising that would appeal to the region. The various services are encoded, modulated and up-converted onto RF carriers, combined onto a single electrical signal and inserted into a broadband optical transmitter. This optical transmitter converts the electrical signal to a downstream optically modulated signal that is sent to the nodes. Fiber optic cables connect the head end to optical nodes in a point-to-point or star topology, or in some cases, in a protected ring topology.

FIG. 2 is a block diagram that illustrates, in detail, one embodiment of the hardware components shown in FIG. 1. In particular, FIG. 2 illustrates the hardware components and software comprising the IDC 160 shown in FIG. 1.

The IDC 160 shown in FIG. 2, in one embodiment, is a general-purpose computing device that performs the present invention. A bus 205 is a communication medium that connects a processor 210, data storage device 215 (such as a Serial ATA (SATA) hard disk drive, optical drive, Small Computer System Interface (SCSI) disk, flash memory, or the like), infrared (IR) interface 220, cable modem 170, QAM processing 180, video output processing 190, and memory 230 (such as Random Access Memory (RAM), Dynamic RAM (DRAM), non-volatile computer memory, flash memory, or the like). The IR interface 220 connects the remote controller 162 to the IDC 160. The cable modem 170 and the QAM processing 180 connect the IDC 160 to the HFC network 140. The video output processing 190 connect the IDC 160 to the television 164, and sends the content that is displayed on the television 170 screen. In one embodiment, the IDC 160 is implemented as an application-specific integrated circuit (ASIC).

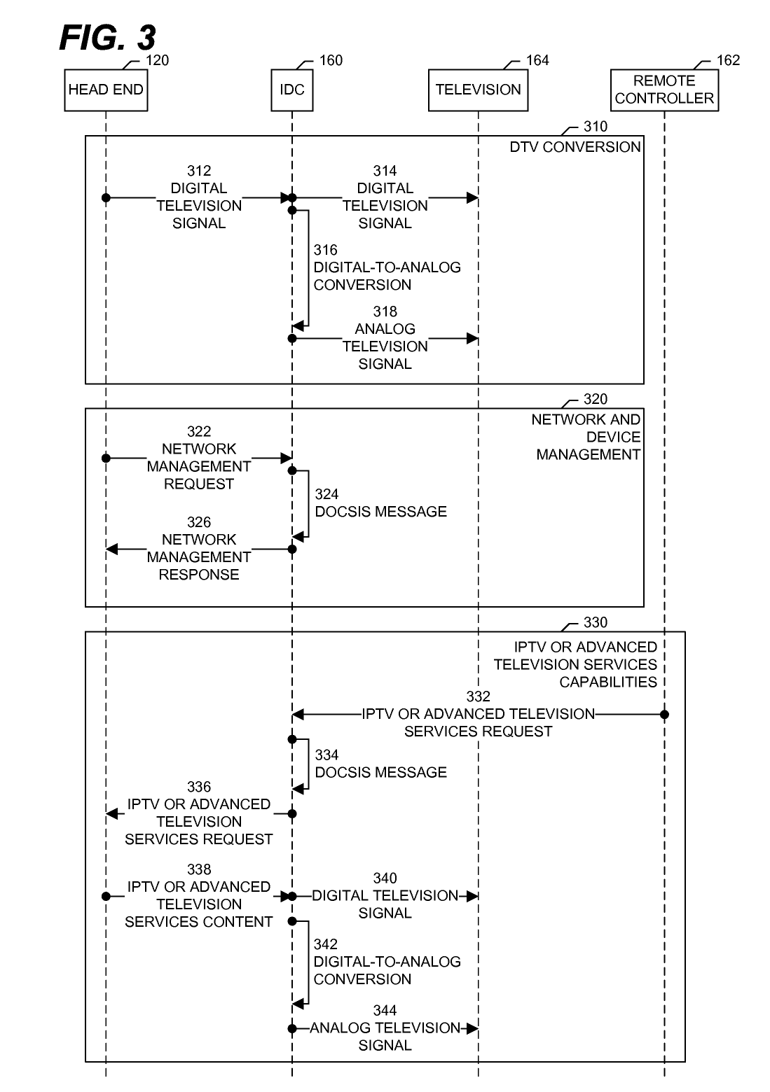

The processor 210 performs the disclosed methods by executing the sequences of operational instructions that comprise each computer program resident in, or operative on, the memory 230. The reader should understand that the memory 230 may include operating system, administrative, and database programs that support the programs disclosed in this application. In one embodiment, the configuration of the memory 230 of the IDC 160 includes an application program 231, and a DOCSIS program 232. The application program 231 is a conventional application program that the cable television operator installs in the set top box 160 such as a video-on-demand (VOD) program, interactive television program, and other next generation television application programs. The DOCSIS program 232 is a program that implements the DOCSIS 3.0 and DOCSIS 2.0 specifications. The application program 231 and DOCSIS program 232 perform the methods of the present invention disclosed in detail in FIG. 3. When the processor 210 performs the disclosed methods, it stores intermediate results in the memory 230 or data storage device 215.

In another embodiment, the memory 230 may swap these programs, or portions thereof, in and out of the memory 230 as needed, and thus may include fewer than all of these programs at any one time.

The IDC 160 reduces the cost compared to that of a traditional set top box by sharing DOCSIS data and video content on a single QAM channel. Since DOCSIS uses the same QAM technology and MPEG-2 transport mechanisms as traditional digital video delivery, the DOCSIS data can be multiplexed with video using MPEG-2 transport on the same QAM channel. The prior art does not utilize this approach because the cost of video delivery through an integrated CMTS was significantly higher than traditional video QAM delivery. However, with the new M-CMTS architecture and the advent of Universal Edge QAM products, it is now feasible and cost effective to mix in-band (i.e., inside the same QAM channel) the downstream DOCSIS data with the video streams being viewed. In one embodiment, the DOCSIS data processed by the IDC 160 is limited to a small amount (e.g., 1 Mbps) to maximize the amount of video content on the QAM channel. In one embodiment, the IDC 160 provides support for DOCSIS 3.0. In another embodiment, the IDC 160 provides support for DOCSIS 2.0.

FIG. 3 is a message flow diagram that illustrates methods according to various embodiments of the present invention. In particular, FIG. 3 illustrates the communication between the head end 120, IDC 160, television 164, and remote controller 162, as shown in FIG. 1 and FIG. 2.

The DTV conversion process 310 shown in FIG. 3 begins when the head end 120 sends a digital television signal to the IDC 160 (step 312). In one embodiment, when the television 164 that connects to the IDC 160 is a digital television, the IDC 160 sends the digital television signal to the television 164 (step 314). In another embodiment, when the television 164 that connects to the IDC 160 is an analog television, the IDC 160 performs a digital-to-analog conversion on the signal (step 316), and sends the analog television signal to the television 164 (step 318). In the embodiment illustrated in the DTV conversion process 310 shown in FIG. 3, the IDC 160 functions as a prior art digital television converter.

The network and device management process 320 shown in FIG. 3 begins when the head end 120 sends a network management request to the IDC 160 (step 322). The IDC 160 sends a DOCSIS message to obtain the requested information (step 324), and sends a network management response to the head end 120 that includes the obtained information (step 326). In one embodiment, the network management request and response messages are simple network management protocol (SMNP) messages.

In the embodiment illustrated in the network and device management process 320 shown in FIG. 3, the IDC 160 functions like a prior art digital television converter, with the increased ability to have increased visibility into their network and the ability to manage all their devices.

The IPTV or advanced television services capabilities process 330 shown in FIG. 3 begins when a subscriber operates a remote controller 162 to send an IPTV or advanced television services request to the IDC 160 (step 332). In another embodiment, the subscriber uses a keypad on the IDC 160 to send this request. The IDC 160 sends a DOCSIS message to communicate the IPTV or advanced television services request (step 334), and sends the IPTV or advanced television services request to the head end 120 (step 336). The head end 120 sends the IPTV or advanced television services content to the IDC 160 in response to the request (step 338). In one embodiment, when the television 164 that connects to the IDC 160 is a digital television, the IDC 160 sends the digital television signal to the television 164 (step 340). In another embodiment, when the television 164 that connects to the IDC 160 is an analog television, the IDC 160 performs a digital-to-analog conversion on the signal (step 342), and sends the analog television signal to the television 164 (step 344).

In the embodiment illustrated in the IPTV or advanced television services capabilities process 330 shown in FIG. 3, the IDC 160 supports channels that are completely traditional MPEG-2 digital video, channels that are completely unicast/multicast DOCSIS IP video, or channels that are the mix of both. The IDC 160 dynamically selects between these supported channels as needed. DOCSIS 3.0 provides several new features that would benefit the IDC 160. While the much publicized Channel Bonding feature provides no benefit to a single tuner device such as the IDC 160, however, the IDC 160 may include and takes advantage of other enhancements in the area of Multicast services, security, and Internet Protocol version 6 (IPv6).

The network and device management process 320 and the IPTV or advanced television services capabilities process 330 shown in FIG. 3 allow the IDC 160 to support all of the functions listed above that is obtained from a low-end STB. In addition, unlike most low-end STBs, the IDC 160 includes a suitable high speed connection for consuming video from the internet (i.e., IPTV or advanced television services). Thus, the DOCSIS connection makes the IDC 160 IPTV or advanced television services capable so that it is well suited for consuming video from the internet, in addition to watching traditional broadcast digital television.

A cable television operator with a large installed base of digital television converter devices would be more reluctant to roll out new services because a significant portion of its subscribers would not have access to it. Thus, any customer with a digital television converter who wants to subscribe to these additional services would require a truck roll from the cable television operator to install the STB. When the subscriber has an IDC 160, the cable television operator is able to roll out new services even faster because it will have an extremely high percentage of subscribers capable of using those features. This creates more average revenue per user (ARPU) for the operator and easily justifies the slight additional cost for the IDC 160.

Thus, the IDC 160 allows the rapid adoption of an all-digital HFC network 140 since it provides a cost point that is close to a prior art digital television converter. However, the inclusion of DOCSIS capabilities in the IDC 160 enables the evolution to a full IPTV capable device that can provide the full range of next generation television features, including the ability to support internet based video.

Although the disclosed embodiments describe a fully functioning video content system and method, the reader should understand that other equivalent embodiments exist. Since numerous modifications and variations will occur to those reviewing this disclosure, the video content system and method is not limited to the exact construction and operation illustrated and disclosed. Accordingly, this disclosure intends all suitable modifications and equivalents to fall within the scope of the claims.

I claim:

1. A video content system, comprising:
a video server connected to a public communication network and a video content network;
a computing device connected to the video content network and a video display device, the computing device comprising:
a memory device resident in the computing device; and
a processor disposed in communication with the memory device, the processor configured to:
establish a communication channel between the computing device and the video server;
receive a digital video stream on the communication channel, the digital video stream including video data and message data, the message data including at least one request to perform a service;
perform the service;
send data on the communication channel, wherein the data is a response to said at least one request to perform the service; and
process the video data.

2. The video content system of claim 1, wherein the video server is a cable television head end facility that includes a cable modem termination system (CMTS), wherein the public communication network is an internet protocol (IP) network, and wherein the video content network is a hybrid fiber-coaxial (HFC) network.

3. The video content system of claim 2, wherein the CMTS comprises:
a modular CMTS (M-CMTS);
an edge quadrature amplitude modulation (EQAM) device; and
a data over cable service interface specification (DOCSIS) timing server.

4. The video content system of claim 1, wherein a cable modem connects the computing device to the video content network.

5. The video content system of claim 1, wherein the communication channel is a single QAM channel that handles video and data delivery.

6. The video content system of claim 1, wherein each request to perform the service is a data over cable service interface specification (DOCSIS) message.

7. The video content system of claim 6, wherein the DOCSIS message comprises at least one of a network management request, an internet protocol television (IPTV) request, and an advanced television services request.

8. The video content system of claim 6, wherein to send the data on the communication channel, the processor is further configured to:
generate a DOCSIS message.

9. The video content system of claim 1, wherein to process the video data, the processor is further configured to:
convert the video data to an analog video signal; and
transmit the analog video signal to the video display device.

10. The video content system of claim 1, wherein the processor is further configured to:
transmit the video data to the video display device.

11. A method, comprising:
establishing a communication channel between a computing device and a video server, wherein the video server is connected to a public communications network and a video content network, and wherein the computing device is connected to the video content network and a video display device;
receiving a digital video stream on the communication channel, the digital video stream including video data and message data, the message data including at least one request to perform a service;
performing the service;
sending data on the communication channel, wherein the data is a response to said at least one request to perform the service; and
processing the video data.

12. The method of claim 11, wherein the video server is a cable television head end facility that includes a cable modem termination system (CMTS), wherein the public communication network is an internet protocol (IP) network, and wherein the video content network is a hybrid fiber-coaxial (HFC) network.

13. The method of claim 11, wherein a cable modem connects the computing device to the video content network.

14. The method of claim 11, wherein the communication channel is a single QAM channel that handles video and data delivery.

15. The method of claim 11, wherein each request to perform the service is a data over cable service interface specification (DOCSIS) message.

16. The method of claim 15, wherein the DOCSIS message comprises at least one of a network management request, an internet protocol television (IPTV) request, and an advanced television services request.

17. The method of claim 15, wherein the sending of the data on the communication channel further comprises:
generating a DOCSIS message.

18. The method of claim 11, wherein the processing of the video data further comprises:
converting the video data to an analog video signal; and
transmitting the analog video signal to the video display device.

19. The method of claim 11, further comprising:
transmitting the video data to the video display device.

20. A computer-readable medium, comprising computer-executable instructions that, when executed on a computing device, perform steps of:
establishing a communication channel between a computing device and a video server, wherein the video server is connected to a public communications network and a video content network, and wherein the computing device is connected to the video content network and a video display device;
receiving a digital video stream on the communication channel, the digital video stream including video data and message data, the message data including at least one request to perform a service;
performing the service;
sending data on the communication channel, wherein the data is a response to said at least one request to perform the service; and
processing the video data.
